(19) United States
(12) Patent Application Publication
(10) Pub. No.: US 2025/0097674 A1
(43) Pub. Date: Mar. 20, 2025

(54) SYSTEMS AND METHODS FOR VERIFICATION OF MESSAGING-BASED NOTIFICATION PERMISSIONS

(71) Applicant: Permissionize LLC, Boulder, CO (US)

(72) Inventors: Shannon Hansen, San Diego, CA (US); Thomas Cutshall, Boulder, CO (US)

(21) Appl. No.: 18/467,980

(22) Filed: Sep. 15, 2023

(51) Int. Cl. H04W 4/14; H04W 12/03

(52) U.S. Cl. CPC H04W 4/14; H04W 12/03

(57) ABSTRACT

Systems and methods to verify messaging-based notification permissions are disclosed. Exemplary implementations may receive a user-initiated request from a user, generate contents for a draft message, transfer information to the user including the contents, receive a text message, perform a verification whether the text message as received includes the contents as generated, notify the user accordingly, and/or perform other steps.

### FIELD OF THE DISCLOSURE

The present disclosure relates to systems and methods to verify messaging-based notification permissions. Individual permissions may be query-specific.

### BACKGROUND

People entering (personal) information in a field or form on a website is known. Providers of online services asking for permission to use personal information is known, e.g., prior to sending notifications to the users. Users providing such permission or consent is known, at least in certain ways.

### SUMMARY

One aspect of the present disclosure relates to a system configured to verify messaging-based notification permissions. The system may include one or more servers including one or more processors. The system may be configured to receive a user-initiated request for a resource, e.g., from a user associated with a client computing platform. The system may be configured to generate contents for a draft message. The system may be configured to transfer information to the user including the contents. The system may be configured to receive a text message. The system may be configured to perform a verification whether the text message as received includes the contents as generated. The system may be configured to notify the user accordingly. The system may be configured to perform other steps.

Another aspect of the present disclosure related to a method of verifying messaging-based notification permissions. The method may include receiving a user-initiated request for a resource, e.g., from a user associated with a client computing platform. The method may include generating contents for a draft message. The method may include transferring information to the user including the contents. The method may include receiving a text message. The method may include performing a verification whether the text message as received includes the contents as generated. The method may include notifying the user accordingly. The method may include other steps.

As used herein, any association (or relation, or reflection, or indication, or correspondency, or correlation) involving servers, processors, client computing platforms, users, requests, resources, webpages, presentations, items of information, queries, topics, permissions, transfers, interfaces, and/or another entity or object that interacts with any part of the system and/or plays a part in the operation of the system, may be a one-to-one association, a one-to-many association, a many-to-one association, and/or a many-to-many association or “N”-to-“M” association (note that “N” and “M” may be different numbers greater than 1).

As used herein, the term “obtain” (and derivatives thereof) may include active and/or passive retrieval, determination, derivation, transfer, upload, download, submission, and/or exchange of information, and/or any combination thereof. As used herein, the term “effectuate” (and derivatives thereof) may include active and/or passive causation of any effect, both local and remote. As used herein, the term “determine” (and derivatives thereof) may include measure, calculate, compute, estimate, approximate, generate, and/or otherwise derive, and/or any combination thereof.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to verify messaging-based notification permissions, in accordance with one or more implementations.

FIG. 2 illustrates a method of verifying messaging-based notification permissions, in accordance with one or more implementations.

FIG. 3 illustrates an example of a user interface, as may be used by a system configured to verify messaging-based notification permissions, in accordance with one or more implementations.

FIG. 4 illustrates an example of a user interface, as may be used by a system configured to verify messaging-based notification permissions, in accordance with one or more implementations.

### DETAILED DESCRIPTION

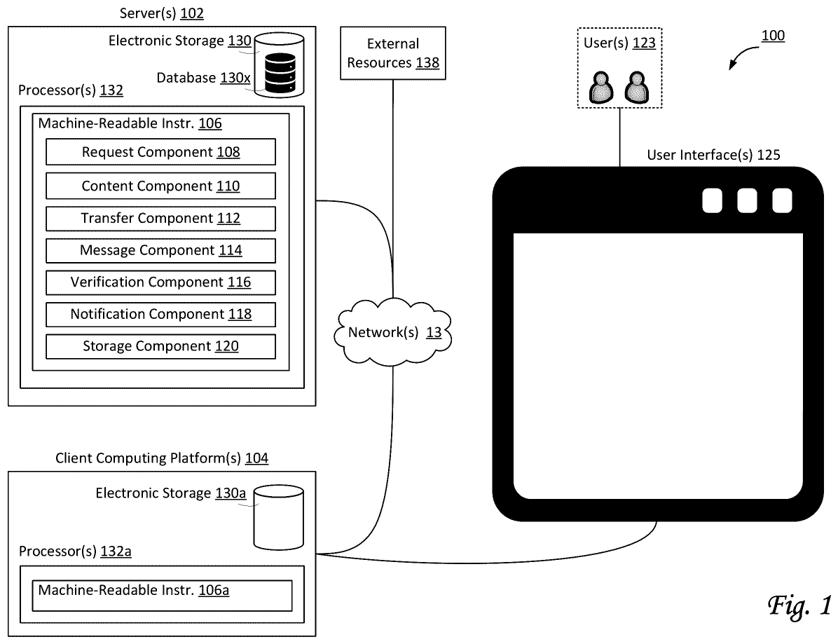

FIG. 1 illustrates a system 100 configured to verify messaging-based notification permissions, in accordance with one or more implementations. As a preliminary and non-limiting example, by virtue of the systems and methods described in this disclosure, users may give permission to receive certain notifications, and these notification permissions may be based on messages, such as text messages. Additionally, these notification permissions may be verified by the system, based on the content of messages. In some cases, individual permissions may be associated with at least one of an organization, a query, a topic, and/or a disclaimer, which may limit future usage of certain user-provided (personal) information. Additionally, by virtue of the systems and methods described in this disclosure, the one or more servers may manage, host, and/or otherwise provide online services, e.g., through one or more webpages, in a manner that ensures that user-provided (personal) information from users has been received and/or otherwise used with the permission of the users. By way of non-limiting example, permission by an individual user may include permission to use the user's personal information and/or permission to notify and/or otherwise contact the individual user.

System 100 may include one or more servers 102, one or more client computing platforms 104, user interface(s) 125, external resource(s) 138, and/or other components. Users 123 (also referred to as users) may include one or more of a first user, a second user, and/or other users. Users 123 may include users who use server(s) 102, directly or indirectly. As used in descriptions herein, any use of the term “user” may refer to user(s) 123, unless indicated otherwise. Individual users may be associated with individual client computing platforms 104, and/or vice versa. As used herein, “local” refers to the client-side or user-side in system 100, whereas “remote” or “server-side” refers to the side of servers 102 in system 100.

Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104. In some implementations, system 100 may be configured to communicate with one or more of server(s) 102, users 123, and/or other entities and/or components, e.g., through one or more networks 13.

Server(s) 102 may include electronic storage 130, (hardware) processor(s) 132, machine-readable instructions 106, and/or other components. Server(s) 102 may be configured by machine-readable instructions 106. Machine-readable instructions 106 may include one or more instruction components. Instruction components (for any set of machine-readable instructions) may include computer program components. The instruction components may include one or more of a request component 108, a content component 110, a transfer component 112, a message component 114, a verification component 116, a notification component 118, a storage component 120, and/or other instruction components. Processor(s) 132a may be similar to processor(s) 132 as described elsewhere in this disclosure, though included in client computing platforms 104, as depicted in FIG. 1. Machine-readable instructions 106a may be similar to machine-readable instructions 106 as described elsewhere in this disclosure, though included in client computing platforms 104, as depicted in FIG. 1. Electronic storage 130a (also referred to as local electronic storage 130a) may be similar to electronic storage 130 as described elsewhere in this disclosure, though included in client computing platforms 104, as depicted in FIG. 1.

Request component 108 may be configured to receive requests from client computing platforms 104, including but not limited to user-initiated requests. In some implementations, requests may be received via a communications network, including but not limited to one or more networks 13. In some implementations, a user-initiated request may be a request for one or more resources, including but not limited to one or more webpages. In some implementations, a user-initiated request may be received at a network location that corresponds to one or more resources and/or webpages. For example, a network location may have a web address, a Uniform Resource Locator (URL), a Uniform Resource Identifier (URI), a Uniform Resource Name (URN), and/or another identifier or location information. For example, a requested resource may correspond to a URL. In some implementations, a user-initiated request may be a HyperText Transfer Protocol (HTTP) request. In some implementations, a user-initiated request may be sent through a browsing application executing on a particular client computing platform 104. The particular client computing platform may be associated with a particular user.

In some implementations, a user-initiated request may be sent through a quick-response (QR) code encountered on a particular client computing platform 104 (e.g., through a camera of client computing platform 104). In some implementations, a user-initiated request may be sent through a link selected by a user of a particular client computing platform 104 (e.g., a QR code encountered through the camera may be presented as a clickable link/hyperlink to the user). Resources and/or webpages may include displayable content, including but not limited to textual information, audio information, image information, video information, animated information, and/or other information capable of being presented to a user of a client computing platform (e.g., through a user interface of the client computing platform).

Content component 110 may be configured to generate and/or otherwise assemble content for messages, including but not limited to text messages. In some implementations, content component 110 may generate content for a draft (text) message. Contents may include one or more of human-readable information, a content identifier, a message identifier, textual information, and/or other information. In some implementations, the human-readable information may include textual information that indicates the user acquiesces (in other words, gives permission) to transfer and/or use of an item of (user-provided) personal information pertaining to the user. For example, personal information may be transferred to and/or used by a particular organization or an organization affiliated with the particular organization.

In some implementations, a content identifier may identify all or some of particular contents. In some implementations, a message identifier may identify all or some of a particular message. In some implementations, identifiers may be created by digitally signing, hashing, and/or otherwise encrypting all or part of certain information (e.g., human-readable information, message content, and/or other information). In some cases, identifiers may be created to ensure data integrity of certain information (e.g., human-readable information, message content, and/or other information). By way of non-limiting example, hash values may be generated using fixed-output-length one-way hashing functions that take variable-length input, and may be effectively impossible (or, at least, computationally infeasible) to reverse. As such, a hashing function may provide one-way encryption. By way of non-limiting example, the hashing function may be (based on) SHA-2 (e.g., SHA-256), BLAKE2, SHA-3 (e.g., SHAKE256), and/or another hashing function. In some cases, a first hashing function such as SHA-256 may be followed by an encoding step to convert (some portion of) the hash value into decimal digits. In some implementations, content component 110 may retrieve information, e.g., from electronic storage 130, that is used to generate content for messages, such as, by way of non-limiting example, disclaimers.

In some implementations, generated content may include and/or refer to organization identifiers, queries, topics, and/or other information. Organization identifiers may identify organizations, including but not limited to corporations, charities, communities, non-profit organizations, and/or other organizations. For example, a particular set of organization identifiers may identify a corresponding set of organizations regarding which a particular permission is transferred and/or received. For example, a particular permission may allow the organizations in a particular set of organizations (say, organizations “A”, “B”, and “C”) to notify the particular user. Queries may pertain to and/or indicate questions and/or requests that a user entered or selected. By way of non-limiting example, “what is the current mortgage rate?” may be a query. Topics may pertain to and/or indicate an area of interest to a user. By way of non-limiting example, “mortgage rates” or “used cars” may be topics. Permissions may be limited in scope and context to one or more queries and/or topics. Such permissions may be referred to as “query-specific permissions”. In some implementations, permissions that are limited in scope and/or context and further limited to particular organizations may be referred to as “limited-scope permissions”. In some implementations, individual disclaimers may indicate a scope and/or context for a particular permission, such as the type of contact and/or notification a user acquiesces to or gives permission for.

In some implementations, personal information may include user identifiers that identify users, such as, e.g., a name, tag, handle, or alias. In some implementations, the user identifiers may include a particular user identifier through which a particular user can receive notifications and/or be identified. For example, such a particular user identifier could include one or more of a phone number, an email address, a user account address, a social security number (SSN), a (residential) home address, a mailing address, an internet protocol (IP) address, a media access control (MAC) address, and/or other information that can be used (in some cases indirectly, by using a suitable database that connects this information to a person) to contact and/or identify the particular user.

Transfer component 112 may be configured to transfer information to client computing platforms 104, e.g., in response to requests from client computing platforms 104. The transferred information may include certain contents, including but not limited to contents and/or other information generated by content component 110. Alternatively, and/or simultaneously, the transferred information may include one or more (implied and/or explicit) instructions for a particular client computing platform 104 and/or an application on the particular client computing platform 104. By way of non-limiting example, the application may be a communication application, a messaging application, a messaging-based communication application, an email application, a chat application, and/or another application.

In some implementations, one or more instructions may effectuate drafting of a draft (text) message for a particular communication application on the particular client computing platform 104. For example, a particular draft message may include certain contents, including but not limited to contents and/or other information generated by content component 110. In some implementations, one or more of the instructions may initiate a Web-based communication referred to as “click-to-text”. In some implementations, one or more of the instructions may instruct a particular client computing platform 104 to launch a particular communication application. In some implementations, one or more of the instructions may redirect a particular client computing platform 104 to a particular communication application. By way of non-limiting example, the particular communication application may send short messaging service (SMS) texts, multimedia messaging service (MMS) messages, instant messages (IM), direct messages (DM), and/or other messages. In some cases, messages are based on the Global System for Mobile Communications (GSM) standards. In some cases, messages are sent over a code-division multiple access (CDMA) network. In some cases, messages are sent over Transmission Control Protocol (TCP)/Internet Protocol (IP).

Message component 114 may be configured to receive messages and/or other information. For example, message component 114 may receive a text message from a particular client computing platform 104. For example, a particular text message may be similar or the same as a draft text message transferred by transfer component 112. In some implementations, message component 114 may receive text messages based on GSM standards. For example, message component 114 may receive SMS texts.

Verification component 116 may be configured to perform verifications. Verifications performed by verification component 116 may operate on received information, including but not limited to information received by message component 114. In some implementations, a particular verification may verify whether a received text message includes the same human-readable information as generated by content component 110. In some implementations, a particular verification may verify whether a received text message includes human-readable information that has not been altered after being generated by content component 110. In some implementations, a particular verification may verify whether a received text message includes the same identifier as generated by content component 110. For example, verification component 116 may verify whether a message identifier as received corresponds to received textual information (e.g., human-readable information) received in the same message. In some implementations, a particular verification by verification component 116 may be based on digitally signing, hashing, and/or otherwise encrypting all or some of a received message. For example, verification component may create a hash value based on all or some of a received message as input, and subsequently compare that hash value to the identifier as received in the same message. Verification component 116 may be configured to perform comparisons as part of a particular verification. Accordingly, matching (hash) values and/or identifiers would indicate a strong likelihood that a user did not alter a draft message before sending it. By virtue of the hashing function, any changes to the draft message would result in a changed hash value, so a mismatch indicates the draft message and/or the identifier has been altered.

In some implementations, content component 110 may create an identifier by hashing only human-readable characters of a text, without including white space (spaces, tabs, newlines, etc.). For example, a particular text (such as a disclaimer) may be first stripped of any white space before being hashed to create a message identifier. Verification component 116 may similarly strip all white space from a received message (excluding the identifier within that same message), and perform a particular verification on the content of the received message after removing the white space. In such a case, adding a space or newline to a draft message (prior to sending) would not cause the particular verification to fail. Of course, changing any wording of the draft message would still cause the particular verification to fail.

Notification component 118 may be configured to notify users, e.g., through notifications. For example, a notification may be sent to a particular client computing platform 104 that is associated with a particular user. In some implementations, notification component 118 may notify a user responsive to a particular verification. For example, responsive to verification component 116 verifying a received text message matches a generated draft message, the particular user may be notified accordingly. In some cases, a notification may confirm to a user that the user has acquiesced to or given permission regarding the transfer and/or use of personal information, including but not limited to a phone number or email address. In some cases, a notification may notify a user that a particular verification failed and/or that the transfer and/or use of personal information has not been agreed to or confirmed.

Storage component 120 may be configured to store information, e.g., electronically. Storage component 120 may store information electronically in electronic storage 130. In some implementations, stored information may include all or part of a (draft) message as generated by content component 110. In some implementations, stored information may include all or part of an identifier as generated by content component 110. In some implementations, stored information may include all or part of information transferred by transfer component 112. In some implementations, stored information may include all or part of a message as received by message component 114. In some implementations, stored information may include information pertaining to verifications by verification component 118.

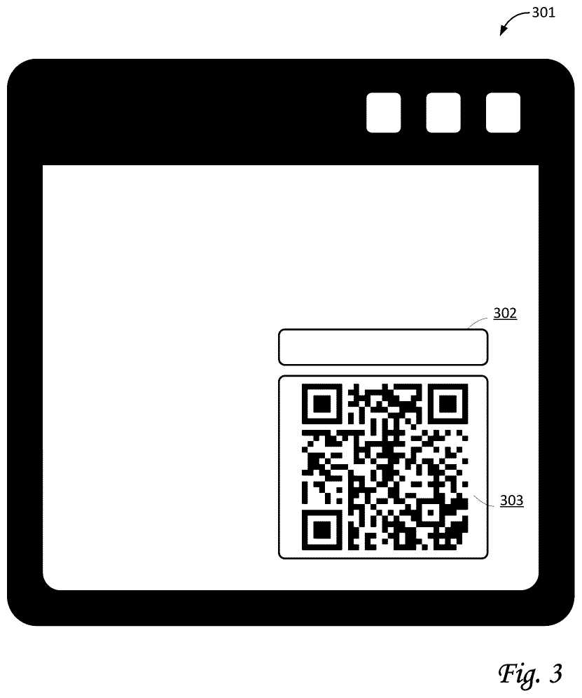

By way of non-limiting example, FIG. 3 illustrates a user interface 301, as may be used during operation of system 100. User interface 301 may be presented on a local client computing platform 104 as a first presentation of a particular webpage (subsequent to a user requesting the particular webpage through, e.g., a browser application executing on the local client computing platform 104). In some cases, user interface 301 may be configured to collect (personal) information from the user. User interface 401 includes various graphical user interface elements, including an information field 302 and a QR code 303. Field 302 may be configured to present information to the user, such as, by way of non-limiting example, one or more of a message to a user, an organization identifier that identifies a particular organization, a particular query or topic, a disclaimer stating the user acquiesces to receiving notifications from the particular organization regarding the particular query or topic, and/or other information. By way of non-limiting example, field 302 may state: “Click the QR code below to learn more about ABC Mortgages.” Responsive to the user engaging QR code 303 (e.g., by aiming a camera of client computing platform 104 at the QR code), user interface 301 may be configured to present a clickable URL link to the user or immediately activate such a link.

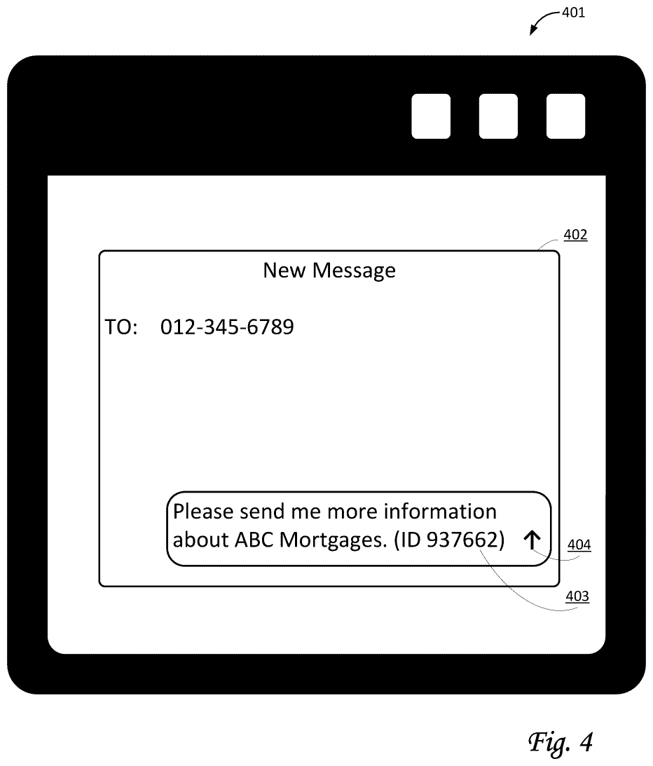

By way of non-limiting example, FIG. 4 illustrates user interface 401, as may be used during operation of system 100. User interface 401 may be configured to present a draft text message 402 to the user. User interface 401 may include various graphical user interface elements, including draft text message 402 and/or other elements. Draft text message 402 may include labels such as “New Message”, a field for a phone number (here, “TO: 012-345-6789”), a field for the (textual) contents of the draft text message (here: “Please send me more information about ABC Mortgages. (ID 937662)”), and/or other information/elements. The first part of the textual contents is the human-readable information “Please send me more information about ABC Mortgages.”. The second part of the textual contents includes a message identifier 403 (here, a numerical identifier, “937662”, which may have been generated from the first part of the contents, e.g., through a hashing function). User interface 401 may include an action button/element 404. Responsive to the user engaging action button/element 404 (e.g., by clicking on the up-arrow), user interface 401 may be configured to initiate a transfer of the draft text message.

Referring to FIG. 1, information regarding permissions may be stored, e.g., in electronic storage 130 and/or in other types of storage. In some implementations, storage component 120 may be configured to store and/or retrieve information in electronic storage, including but not limited to electronic storage 130. For example, certain permissions may be organized in database 130x for future access. Database 130x (which may, for example, be part of electronic storage 130) may be queried for the current status of a particular user's permissions. In some cases, database 130x may be queried for an overview of certain permissions and/or other information pertaining to a particular user.

Referring to FIG. 1, user interfaces 125 may be configured to facilitate interaction between users 123 and system 100 and/or between users 123 and client computing platforms 104. For example, user interfaces 125 may provide an interface through which users 123 may provide information to and/or receive information from system 100, and/or vice versa. In some implementations, user interface 125 may include one or more of a display screen, touchscreen, monitor, a keyboard, buttons, switches, knobs, levers, mouse, microphones, sensors to capture voice commands, sensors to capture body movement, sensors to capture hand and/or finger gestures, and/or other user interface devices configured to receive and/or convey user input. In some implementations, one or more user interfaces 125 may be included in one or more client computing platforms 104. In some implementations, one or more user interfaces 125 may be included in system 100. In some implementations, user interface 125 may include one or more frames, borders, page sections, buttons, and/or other elements.

Referring to FIG. 1, in some implementations, server(s) 102, client computing platform(s) 104, and/or external resources 138 may be operatively linked via one or more electronic communication links. For example, such electronic communication links may be established, at least in part, via one or more networks 13 such as the Internet and/or other networks. It will be appreciated that this is not intended to be limiting, and that the scope of this disclosure includes implementations in which server(s) 102, client computing platform(s) 104, and/or external resources 138 may be operatively linked via some other communication media.

A given client computing platform 104 may include one or more processors configured to execute computer program components. The computer program components may be configured to enable an expert or user associated with the given client computing platform 104 to interface with system 100 and/or external resources 138, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a watch, a gaming console, and/or other computing platforms.

External resources 138 may include sources of information outside of system 100, external entities participating with system 100 (including third parties such as external web-servers for different organizations), external providers of computation and/or storage services (e.g., a publicly accessible server external to system 100), and/or other resources. In some implementations, external resources 138 may include one or more online service providers configured to notify a particular set of users, e.g., on behalf of a particular set of organizations. In some implementations, some or all of the functionality attributed herein to external resources 138 may be provided by resources included in system 100.

Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 130 may comprise non-transitory storage media that electronically stores information. The electronic storage media of electronic storage 130 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 130 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 130 may include one or more virtual storage resources (e.g., cloud storage, a virtual private network, and/or other virtual storage resources). Electronic storage 130 may store software algorithms, information determined by processor(s) 132, information received from server(s) 102, information received from client computing platform(s) 104, and/or other information that enables server(s) 102 to function as described herein. Local electronic storage 130a may be similar to electronic storage 130 as described elsewhere in this disclosure.

Processor(s) 132 may be configured to provide information processing capabilities in server(s) 102. As such, processor(s) 132 may include one or more of a digital processor, an analog processor, a digital circuit designed to process information, an analog circuit designed to process information, a state machine, and/or other mechanisms for electronically processing information. Although processor(s) 132 is shown in FIG. 1 as a single entity, this is for illustrative purposes only. In some implementations, processor(s) 132 may include a plurality of processing units. These processing units may be physically located within the same device, or processor(s) 132 may represent processing functionality of a plurality of devices operating in coordination. Processor(s) 132 may be configured to execute components 108, 110, 112, 114, 116, 118, and/or 120, and/or other components. Processor(s) 132 may be configured to execute components 108, 110, 112, 114, 116, 118, and/or 120, and/or other components by software; hardware; firmware; some combination of software, hardware, and/or firmware; and/or other mechanisms for configuring processing capabilities on processor(s) 132. As used herein, the term “component” may refer to any component or set of components that perform the functionality attributed to the component. This may include one or more physical processors during execution of processor-readable instructions, the processor readable-instructions, circuitry, hardware, storage media, or any other components.

It should be appreciated that although components 108, 110, 112, 114, 116, 118, and/or 120 are illustrated in FIG. 1 as being implemented within a single processing unit, in implementations in which processor(s) 132 includes multiple processing units, one or more of components 108, 110, 112, 114, 116, 118, and/or 120 may be implemented remotely from the other components. The description of the functionality provided by the different components 108, 110, 112, 114, 116, 118, and/or 120 described below is for illustrative purposes only, and is not intended to be limiting, as any of components 108, 110, 112, 114, 116, 118, and/or 120 may provide more or less functionality than is described. For example, one or more of components 108, 110, 112, 114, 116, 118, and/or 120 may be eliminated, and some or all of its functionality may be provided by other ones of components 108, 110, 112, 114, 116, 118, and/or 120. As another example, processor(s) 132 may be configured to execute one or more additional components that may perform some or all of the functionality attributed below to one of components 108, 110, 112, 114, 116, 118, and/or 120.

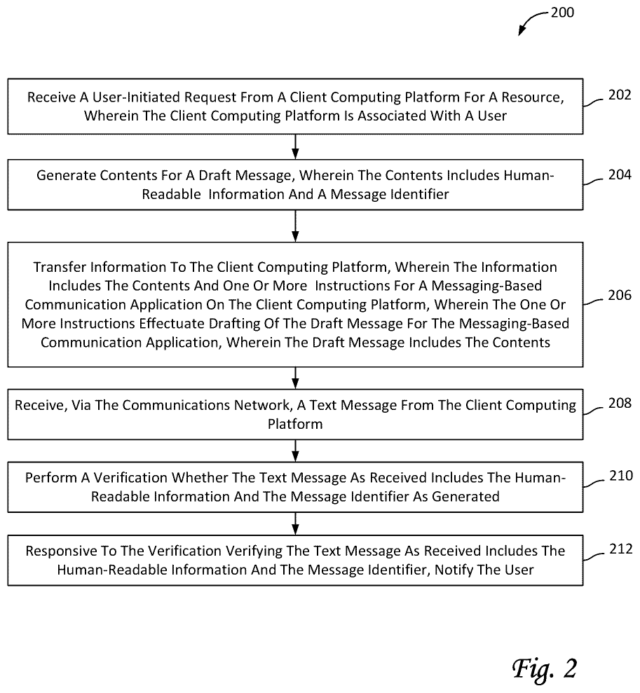

FIG. 2 illustrates a method 200 of verifying messaging-based notification permissions, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

Regarding method 200, at an operation 202, a user-initiated request is received, via a communications network, from a client computing platform for a resource. The client computing platform is associated with a user. In some embodiments, operation 202 is performed by a request component the same as or similar to request component 108 (shown in FIG. 1 and described herein).

At an operation 204, contents for a draft message is generated. The contents includes human-readable information and a message identifier. In some embodiments, operation 204 is performed by a content component the same as or similar to content component 110 (shown in FIG. 1 and described herein).

At an operation 206, information is transferred to the client computing platform. The information includes the contents and one or more instructions for a messaging-based communication application on the client computing platform. The one or more instructions effectuate drafting of the draft message for the messaging-based communication application. The draft message includes the contents. In some embodiments, operation 206 is performed by a transfer component the same as or similar to transfer component 112 (shown in FIG. 1 and described herein).

At an operation 208, a text message is received, via the communications network, from the client computing platform. In some embodiments, operation 208 is performed by a message component the same as or similar to message component 114 (shown in FIG. 1 and described herein).

At an operation 210, a verification is performed whether the text message as received includes the human-readable information and the message identifier as generated. In some embodiments, operation 210 is performed by a verification component the same as or similar to verification component 116 (shown in FIG. 1 and described herein).

At an operation 212, responsive to the verification verifying the text message as received includes the human-readable information and the message identifier, the user is notified. In some embodiments, operation 212 is performed by a notification component the same as or similar to notification component 118 (shown in FIG. 1 and described herein).

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. It is to be understood that the present technology contemplates that, to the extent possible, one or more features of any implementation can be combined with features of any other implementation.

What is claimed is:

1. A system configured to verify messaging-based notification permissions, the system comprising:
one or more servers including one or more processors configured by machine-readable instructions to:
receive, via a communications network, a user-initiated request from a client computing platform for a resource, wherein the client computing platform is associated with a user;
generate contents for a draft message, wherein the contents includes human-readable information and a message identifier;
transfer information to the client computing platform, wherein the information includes the contents and one or more instructions for a messaging-based communication application on the client computing platform, wherein the one or more instructions effectuate drafting of the draft message for the messaging-based communication application, wherein the draft message includes the contents;
receive, via the communications network, a text message from the client computing platform;
perform a verification whether the text message as received includes the human-readable information and the message identifier as generated; and
responsive to the verification verifying the text message as received includes the human-readable information and the message identifier, notify the user.

2. The system of claim 1, wherein the user-initiated request is received responsive to the user selecting and/or engaging with a link and/or a quick-response (QR) code on the client computing platform.

3. The system of claim 1, wherein the resource corresponds to a uniform resource locator (URL).

4. The system of claim 1, wherein the human-readable information includes textual information that indicates the user acquiesces to a transfer of a first item of user-provided personal information pertaining to the user to a first organization or to an organization affiliated with the first organization.

5. The system of claim 4, wherein the textual information indicates the user acquiesces to receiving notifications using the first item of user-provided personal information, wherein the notifications pertain to the first organization or the organization affiliated with the first organization.

6. The system of claim 1, wherein the message identifier is created by hashing all or part of the human-readable information.

7. The system of claim 1, wherein the one or more instructions instruct the client computing platform to launch the messaging-based communication application.

8. The system of claim 1, wherein the verification is based on hashing all or part of the text message as received.

9. The system of claim 1, wherein the one or more processors are further configured to:
responsive to the verification verifying the text message as received includes the human-readable information and the message identifier, store information in electronic storage, wherein the stored information includes a first item of user-provided personal information pertaining to the user.

10. The system of claim 9, wherein the stored information further includes the human-readable information.

11. A method of verifying messaging-based notification permissions, the method comprising:
receiving, via a communications network, a user-initiated request from a client computing platform for a resource, wherein the client computing platform is associated with a user;
generating contents for a draft message, wherein the contents includes human-readable information and a message identifier;
transferring information to the client computing platform, wherein the information includes the contents and one or more instructions for a messaging-based communication application on the client computing platform, wherein the one or more instructions effectuate drafting of the draft message for the messaging-based communication application, wherein the draft message includes the contents;
receiving, via the communications network, a text message from the client computing platform;
performing a verification whether the text message as received includes the human-readable information and the message identifier as generated; and
responsive to the verification verifying the text message as received includes the human-readable information and the message identifier, notifying the user.

12. The method of claim 11, wherein the user-initiated request is received responsive to the user selecting and/or engaging with a link and/or a quick-response (QR) code on the client computing platform.

13. The method of claim 11, wherein the resource corresponds to a uniform resource locator (URL).

14. The method of claim 11, wherein the human-readable information includes textual information that indicates the user acquiesces to a transfer of a first item of user-provided personal information pertaining to the user to a first organization or to an organization affiliated with the first organization.

15. The method of claim 14, wherein the textual information indicates the user acquiesces to receiving notifications using the first item of user-provided personal information, wherein the notifications pertain to the first organization or the organization affiliated with the first organization.

16. The method of claim 11, wherein the message identifier is created by hashing all or part of the human-readable information.

17. The method of claim 11, wherein the one or more instructions instruct the client computing platform to launch the messaging-based communication application.

18. The method of claim 11, wherein the verification is based on hashing all or part of the text message as received.

19. The method of claim 11, further comprising:
responsive to the verification verifying the text message as received includes the human-readable information and the message identifier, storing information in electronic storage, wherein the stored information includes a first item of user-provided personal information pertaining to the user.

20. The method of claim 19, wherein the stored information further includes the human-readable information.
